(19) United States
(12) Patent Application Publication
(10) Pub. No.: US 2012/0011387 A1
(43) Pub. Date: Jan. 12, 2012

(54) OPERATION METHOD FOR HOST APPARATUS TO SAVE POWER CONSUMPTION

(75) Inventors: Johnny Chen, Santa Ana, CA (US); Ping-Shun Zeung, Santa Ana, CA (US)

(73) Assignee: I/O INTERCONNECT, LTD., Santa Ana, CA (US)

(21) Appl. No.: 13/088,533

(22) Filed: Apr. 18, 2011

Related U.S. Application Data
(60) Provisional application No. 61/361,896, filed on Jul. 6, 2010.

(51) Int. Cl. G06F 1/32

(52) U.S. Cl. 713/324

(57) ABSTRACT

An operation method for a host apparatus is provided. When a peripheral device connects to the host apparatus through a data transmission interface, the host apparatus is checked whether or not accessing data with the peripheral device. When the host apparatus doesn't access data with the peripheral device continuing a predetermined time, the peripheral device is shut down to make the peripheral device entering a power saving mode from a normal operation mode but an interrupt operation of the data transmission interface is still activated. When the host apparatus need to access data with the peripheral device being in the power saving mode, the interrupt operation is triggered for waking the peripheral device up to revive the peripheral device working under the normal operation mode.

### CROSS-REFERENCE TO RELATED APPLICATIONS

The application claims priority of U.S. provisional patent application Ser. No. 61/361,896 filed on Jul. 6, 2010, the contents of which are hereby incorporated by reference.

### FIELD OF THE INVENTION

The present invention relates to a power saving technology, and more particularly to a power saving technology for saving power consumption of a peripheral device linking to a host apparatus.

### BACKGROUND OF THE INVENTION

Universal serial bus (USB) is a standard of serial bus for linking a computer to some peripheral devices, and also a specification of I/O interface. Through the USB interface, a host apparatus can connects a plurality of peripheral devices, such like mouse, keyboard, joystick, scanner, digital camera, print, external HDD, etc.

Generally, the operation modes of USB include control, interrupt isochronous, bulk modes etc. In conventional skill, when a peripheral device which links to a host apparatus through the USB interface is asked to enter a power saving mode, a system of the host apparatus need to enter the power save mode first. Then, the peripheral device follows the host apparatus to enter the power saving mode. Meanwhile, all operation between the host apparatus and the peripheral device is disabled. Therefore, the conventional skill can save power consumption when the host apparatus is idled at a long time.

However, in some situations, such like a user operates the host apparatus without accessing data with the peripheral device linking to the host apparatus through the USB interface. Meanwhile, the peripheral cannot enter the power saving mode along. Therefore, though the peripheral device is idled, the peripheral device still consumes power. In this situation, for some host apparatuses such like portable host apparatus, the using time would be shorted because of the power consumption as above description.

### SUMMARY OF THE INVENTION

Therefore, the present invention provides a host apparatus has less power consumption.

The present invention further provides an operation method for a host apparatus to improve the power efficiency of the host apparatus.

Furthermore, the present invention provides a storage media in which a power saving application program for assisting the host apparatus saving power consumption.

A host apparatus provided by the present invention comprises a control module, a storage unit, an interface module. The control module couples to the storage unit and the interface module respectively. In the storage unit, a power saving application program is installed. In addition, the interface module has at least one connection port. When a peripheral device connects to the connection port and the power saving application program checks that the control module doesn't access data with the peripheral device through the connection port continuing a predetermined time, the peripheral device is shut down by the power saving application program but an interrupt operation of the interface module is still activated.

In one embodiment of the present invention, the connection port is USB port.

In another viewpoint, an operation method for a host apparatus is provided by the present invention comprising checking whether or not the host apparatus accesses data with a peripheral device, when the peripheral device connects to the host apparatus through a data transmission interface. When the host apparatus doesn't access data with the peripheral device continuing a predetermined time, the peripheral device is shut down to make the peripheral device entering a power saving mode from a normal operation mode but an interrupt operation of the data transmission interface is still activated. When the host apparatus need to access data with the peripheral device being in the power saving mode, the interrupt operation is triggered for waking the peripheral device up to revive the peripheral device working under the normal operation mode.

In one embodiment, the data transmission interface is USB interface.

In another viewpoint, a storage media is provided by the present invention which has a power saving application program. The steps performed by the power saving application program comprise monitoring the host apparatus whether or not accessing data with a peripheral device through a data transmission interface. When the host apparatus doesn't access data with the peripheral device continuing a predetermined time, the peripheral device is shut down to make the peripheral device entering a power saving mode from a normal operation mode but an interrupt operation of the data transmission interface is still activated. When the host apparatus need to access data with the peripheral device being in the power saving mode, waking up the peripheral device allows the host apparatus accessing data with the peripheral device again.

In one embodiment of the present invention, the steps of waking the peripheral device comprise monitoring a status of the interrupt operation when the peripheral device is in the power saving mode. When the interrupt operation is triggered used for responding the data access request, the power saving application program wakes up the peripheral device.

Since the peripheral device can be shut down as the data access operation of the host apparatus with the peripheral device stopping continuing a predetermined time, the present invention can save power consumption of the host apparatus effectively, and thereby improve the power efficiency of the host apparatus.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a block diagram of a host apparatus according to one preferred embodiment of the present invention.

FIG. 2 shows a block diagram of the interface module according to one preferred embodiment of the present invention.

FIGS. 3A and 3B show a flow chart of an operation method for a host apparatus according to one preferred embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

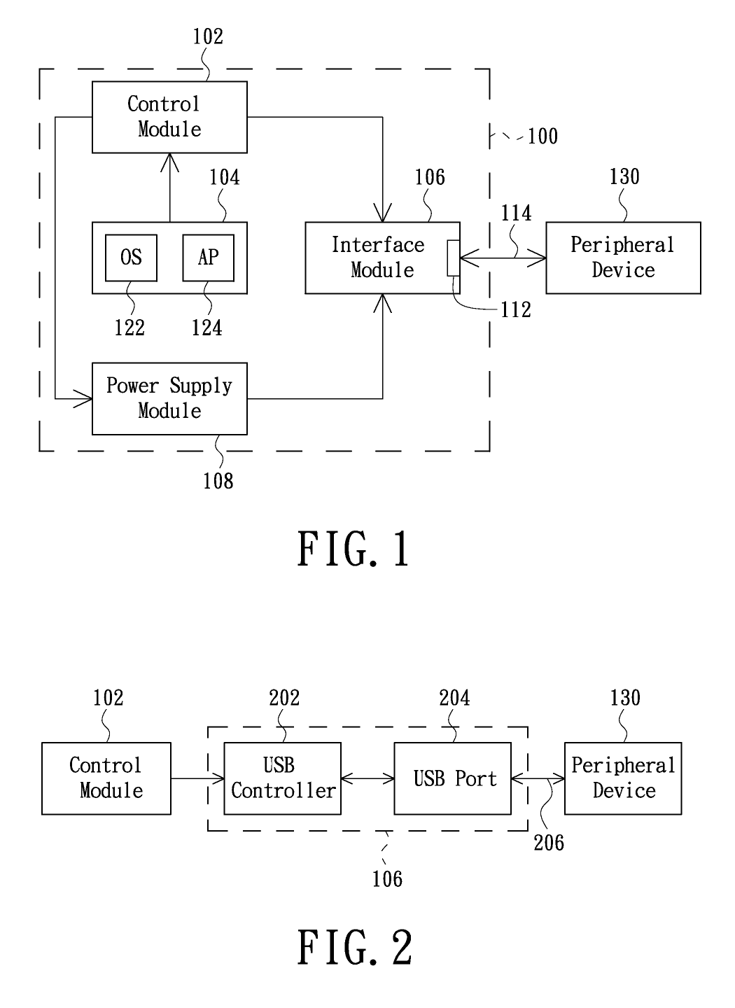

FIG. 1 is a block diagram of a host apparatus according to one preferred embodiment of the present invention. Referring FIG. 1, the host apparatus 100, such as a notebook computer, a portable computer, a tablet computer (pad), etc., comprises a control module 102, a storage unit 104, and an interface module 106. The control module 102 couples to the storage unit 104 and the interface module 106. Wherein, the interface module 106 has at least one connection port, such as connection port 112. Therefore, a peripheral device 130, such like a printer, a scanner, a monitor, a keyboard, a mouse, an external HDD, a joystick, a digital camera, a digital music player . . . etc., can connect to the connection port 112 through a data transmission line 114. When the peripheral device 130 connects to the connection port 112, the control module 102 has ability to access data with the peripheral device through the interface module 106.

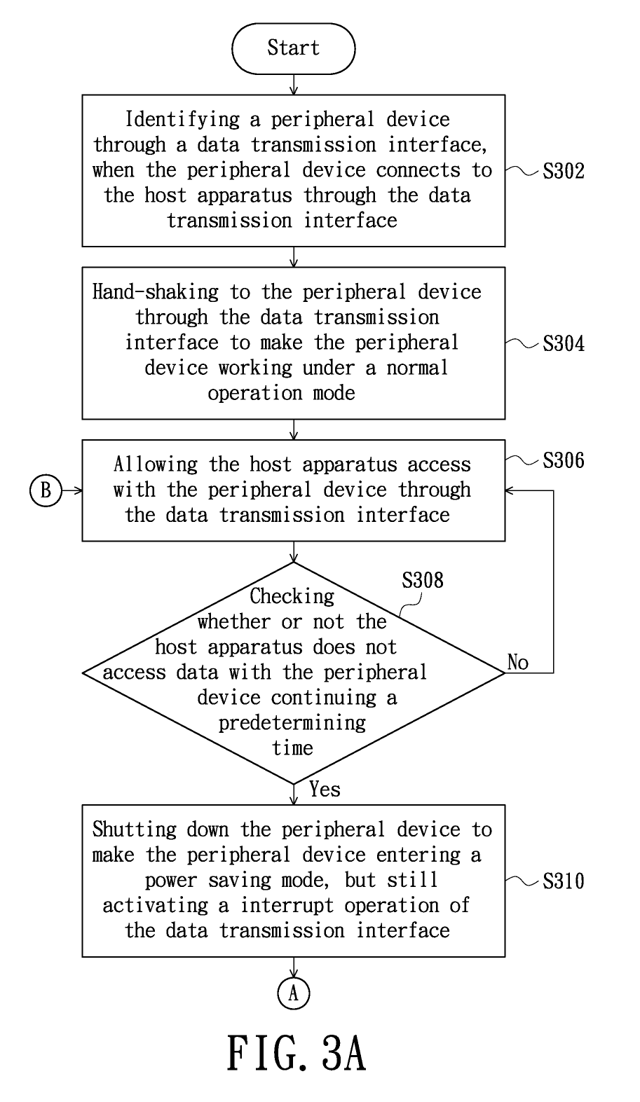

The interface module 106 has a plurality of operation modes. One of the operation modes is an interrupt operation. In an exemplary embodiment, the interface module 106 is probably a USB module. FIG. 2 shows a block diagram of the interface module 106 according to one preferred embodiment of the present invention. Referring FIG. 2, in this exemplary embodiment, the interface module 106 is probably a USB (Universal Serial Bus) module, which has a USB controller 202 and at least one USB port 204 as the connection port 112 in FIG. 1. The controller 202 couples to the USB port 204 and the control module 102. In this exemplary embodiment, the peripheral device 130 connects to the USB port 204 through a USB transmission line 206 as the transmission line 114 in FIG. 1. In following description, the interface module 106 is seen but not limited to be the USB module.

Referring FIG. 1 again, the storage unit 104 is probably an internal HDD, a flash memory, a memory card or an optical storage media etc. In this exemplary embodiment, an operation system (OS) 122 and a power saving application program 124 are installed in the storage unit 104.

In addition, the host apparatus 100 further has a power supply module 108. The power supply module 108 connects to the commercial power for supplying a work power to the host apparatus 100 for working. In this exemplary embodiment, the power supply module 108 couples to the control module 102 and the interface module 106. Wherein, the interface module 106 converses the output power of the power supply module 108 into an interface power with a predetermined voltage level, such as 5V.

When the peripheral device 130 connects to the connection port 106 through the data transmission line 114, the control module 102 identifies the peripheral device 130 through the interface module 106. In addition, the control module 102 would hand-shank the peripheral device 130 for establishing a data access link between the host apparatus 100 and the peripheral device 130. When the data access link is established, the control module 102 controls the interface module 106 supplying the interface power to a main circuit of the peripheral device 130 for starting the peripheral device 130. Meanwhile, the peripheral device 130 works under a normal operation mode, and thereby the control module 102 is allowed to access with the peripheral device 130 through the interface module 106.

In this exemplary embodiment, when the power saving application program 124 is started, the control module 102 would load the power saving application program 124. At this time, the power saving application program 124 would monitor whether or not the control module 102 access data with the peripheral device 130 continually. In some situation, such like the peripheral device being idled, the control module 102 wouldn't access data with the peripheral device 130. In such situations, when the power saving application program 124 checks that the control module 102 doesn't access data with the peripheral device 130 continuing a predetermined time, the power saving application program 124 notices the control module 102 to control the interface module 106 stopping supplying the interface power to the main circuit of the peripheral 130 through the interface module 106, so as to shut the peripheral device 130 down. Meanwhile, the peripheral device 130 enters a power saving mode.

When the peripheral device 130 enters the power saving mode, most of operations between the interface module 106 and peripheral device 130 are also shut down by the power saving application program 124 except the interrupt operation. Due to the interrupt operation is activated, the power saving application program 124 monitors a status of the interrupt operation as the peripheral device 130 being in the power saving mode.

When the control module 102 requires to access data with the peripheral device 130 being in the power saving mode, the control module 102 issues a data access request. In some embodiments, for responding the data access request, the interrupt operation is triggered. Therefore, when the power saving application program 124 checks that the interrupt operation is triggered, the power saving application program 124 notices the control module 102 controlling the interface module 106 to supply the interface power to the main circuit of the peripheral device 130 again, so as to wake up the peripheral device 130. Meanwhile, the peripheral device 130 works under the normal operation mode again, so that the control module 102 can access data with the peripheral device 130.

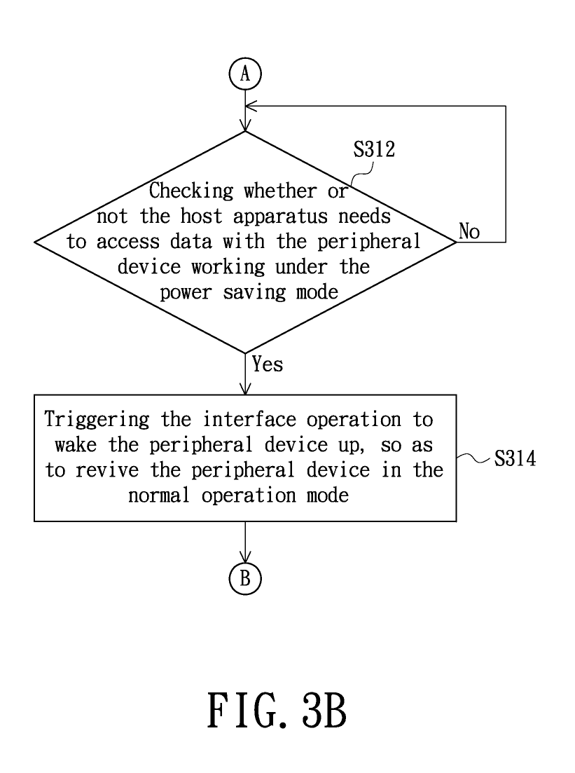

FIGS. 3A and 3B show a flow chart of an operation method for a host apparatus according to one preferred embodiment of the present invention. Referring FIGS. 3A and 3B together, as description in step S302, when a peripheral device connects to the host apparatus through a data transmission interface, such like USB interface, making the apparatus identifies the peripheral device through the data transmission interface. Then, making the host apparatus hand-shakes to the peripheral device through the data transmission interface, so as to make the peripheral device works under a normal operation mode, as description in the step S304. Therefore, the host apparatus, as description in the step S306, is allowed to access data with the peripheral device through the data transmission interface.

Meanwhile, the step S308 is performed to check whether or not the host apparatus doesn't access data with the peripheral device continuing a predetermined time. If the host apparatus accesses data with the peripheral device in the predetermined time (i.e. “No” labeled in the step S308), the step S308 would be repeated again. On the contrary, if the host apparatus doesn't access data with the peripheral device in the predetermined time (i.e. “Yes” labeled in the step S308), the step S310 would be performed to shut down the peripheral device to make the peripheral device entering a power saving mode. In the step S310, when the peripheral device enters the power saving mode, an interrupt operation of the data transmission interface is still activated.

In addition, the step S312 is performed to check whether or not the host apparatus need to access data with the peripheral device being in the power saving mode. If the host apparatus requires to access data with the peripheral being in the power saving mode (i.e. “Yes” labeled in the step S312), a data power request is issued by the host apparatus, such as triggering the interrupt operation, for waking the peripheral device up, so as to revive the peripheral device working under the normal operation mode again, as description in the step S314. Then, the step 306 is performed repeatedly.

In summary, the peripheral device can be shut down in the idled status, such that the present invention can save the power consumption. In addition, since the interrupt operation is still activated as the peripheral device being in the power saving mode, the host apparatus can revive accessing data with the peripheral device anytime.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A host apparatus, comprising:
a control module;
a storage unit, coupling to the control module and having a power saving application program; and
an interface module, coupling to the control module and having at least one connection port,
wherein when a peripheral device connects to the connection port and the power saving application program checks that the control module doesn't access data with the peripheral device through the connection port continuing a predetermined time, the peripheral device is shut down by the power saving application program but an interrupt operation of the interface module is still activated.

2. The host apparatus according to claim 1, wherein connection port is a USB port.

3. The host apparatus according to claim 2, wherein the interface module further has a USB controller coupling to the USB port.

4. An operation method for a host apparatus, comprising:
checking whether or not the host apparatus accesses data with a peripheral device, when the peripheral device links to the host apparatus through a data transmission interface;
shutting down the peripheral device but still activating an interrupt operation of the data transmission interface between the peripheral device and the host apparatus to make the peripheral device entering a power saving mode from a normal operation mode, when the host apparatus doesn't access data with the peripheral device continuing a predetermined time; and
triggering the interrupt operation for waking the peripheral device up to revive the peripheral device working under the normal operation mode, when the host apparatus need to access data with the peripheral device in the power saving mode.

5. The operation method according to claim 4, further comprising:
identifying the peripheral device through the data transmission interface, when the peripheral device connects to the data transmission interface;
hand-shaking the peripheral device; and
supplying power to the peripheral device through the data transmission interface to make the peripheral device working under the normal operation mode, such that the host apparatus can access data with the peripheral device through the data transmission interface.

6. The operation method according to claim 5, the step of shutting down the peripheral device is stopping supplying power to a main circuit of the peripheral device.

7. The operation method according to claim 5, wherein the step of waking the peripheral device is reviving supplying power to a main circuit of the peripheral device

8. The operation method according to claim 4, wherein the data transmission interface is USB interface.

9. A storage media has a power saving application program suitable for a host apparatus, and the steps performed by the power saving application program comprise:
monitoring the host apparatus whether or not accessing data with a peripheral device through a data transmission interface;
shutting down the peripheral device but still activating an interrupt operation of the data transmission interface between the host apparatus and the peripheral device, so as to make the peripheral device entering a power saving mode from a normal operation mode, when checking that the host apparatus doesn't access data with the peripheral device continuing a predetermined time; and
waking the peripheral device up for responding a data access request from the host apparatus to allow the host apparatus accessing data with the peripheral device again, when the host apparatus need to access data with the peripheral device being in the power saving mode.

10. The storage media according to claim 9, wherein the step of shutting down the peripheral device is noticing the host apparatus to stop supplying power to the peripheral device through the data transmission interface.

11. The storage media according to claim 9, wherein the steps of waking the peripheral device up comprise:
monitoring a status of the interrupt operation when the peripheral device works under the power saving mode; and
waking the peripheral device up, when the interrupt operation is triggered used for responding the data access request.

12. The storage media according to claim 9, wherein the data transmission interface is USB interface.
